(19) United States
(12) Patent Application Publication
(10) Pub. No.: US 2011/0132726 A1
(43) Pub. Date: Jun. 9, 2011

(54) Baggage Claim Security Device

(76) Inventors: Robert M. Wiese, Eustis, FL (US); John William Cottrell, III, Clermont, FL (US)

(21) Appl. No.: 12/957,191

(22) Filed: Nov. 30, 2010

Related U.S. Application Data
(60) Provisional application No. 61/264,887, filed on Nov. 30, 2009.

(51) Int. Cl. B65G 15/22

(52) U.S. Cl. 198/602; 198/618

(57) ABSTRACT

The secure baggage claim apparatus and method centers on a dynamic merge conveyor unit that feeds into a standard baggage claim unit. The dynamic merge actively measures every space and every bag. Once the merge determines sufficient spacing for an individual bag, the dynamic merge will accelerate a bag into the open space on the baggage claim unit. Such dynamic merging greatly improves the throughput and capacity of baggage drop off and delivery. The entire baggage claim unit resides within the passenger sector of baggage claim. Current configurations allow bags to freely circulate between the secure and non-secure side of the baggage claim area. With the present invention, bags are prevented from circulating back and forth from the secure side to the non-secure side, which prevents an individual on the non-secure public side from placing a bag on a baggage claim unit where it will then be circulated and unscreened into the secure side for a baggage handler to retrieve such bag.

### FIELD OF THE INVENTION

The general subject of the invention is a new security configuration for airport baggage claim devices utilizing at least a dynamic merge conveyor and a baggage claim unit to prevent circulating bags from reentering a secured loading area.

### SUMMARY OF INVENTION

The baggage security claim device adds enhanced security to bags awaiting pickup at an airports claims carousel location. At present, unclaimed bags circulate on the claims carousel, periodically returning to the secured load area without proper TSA screening through an open security door. This present configuration allows an individual at the carousel to introduce an unchecked bag onto the carousel to be retrieved by another individual standing behind the security wall or barrier. The new security claim unit utilizes one exit from the load area with no bags returning or recirculating back to the load area. The unload operations personnel will transfer baggage from the airline tug carts to a main load conveyor. The load conveyor advances the bags to a queue belt for length measurement, then through a power turn, to a merge. The merge will hold the bag until an adequate gap between bags already on the claim device is measured. The merge will then perform a dynamic merge on the waiting bag into the gap on the flat plate claim device for pickup by the traveler. If the claim device is full, the load conveyor, the merge, power turn, and queue will act as a storage conveyor. The load conveyor will stop; however, the unload personnel can continue to unload bags from the tug cart until the load conveyor is full. When gaps of the required size are measured on the claim device, the merge will resume operation by automatically inserting the stored bags onto the claim device.

### Dynamic Merge Compared To Static Merge

When merging bags from one conveyor line to another, some kind of merge logic is required to prevent collisions between bags, and in most cases, to guarantee that the minimum gap space is maintained as each bag is merged.

The simplest bag merging method, though not the most efficient, is called the static merge or fixed merge design. This type of merge is typically used in conventional conveyor systems where throughput and bag tracking requirements are not as stringent. A merge window photo eye is located in the main line, upstream of the merge point. This photo eye is installed far enough upstream so that sufficient space is available for the largest bag the system can handle, while allowing sufficient space between bags. A timer usually controls this fixed window. When the upstream photo eye is cleared for the time desired, a merge window becomes available and the bag waiting in the merging line is released. The disadvantage of this type of merge is that a small bag is treated the same as the largest bag and conveyor space is not maximized.

### EXAMPLE

As an example, a 54″ bag that requires a 6″ gap ahead and a 6″ gap behind would require a fixed merge window of 66″. If a 22″ bag was merged into the same fixed window with the same 6″ gap ahead and 6″ gap behind, the bag would only use 34″ of the 66″ window. If a gap of 34″ was presented to the 22″ bag, the bag would not merge because the fixed gap length would be smaller than the allowable 66″. Therefore, possible merge windows that could be used for merging bags onto a conveyor are ignored.

The most efficient way to merge bags can be achieved using what is called dynamic merge. This type of merge does not use a fixed size window. Instead, the size of the merge window is dynamically adjusted with every bag that is to be merged, based on the size of each bag and the variable front and back gap settings. This requires measuring the length of the bag on the merging line and looking for the appropriate gap on the receiving belt that can accept the merging bag's size plus the minimum front and back bag space required. Throughput is increased since lost space (translated into waiting time) from small bags is regained compared to the fixed merge technique. In addition to the merge window photo eye, this logic requires a virtual encoder on the upstream pre-merge conveyor to measure the bag length of the merging bags.

Using the previous example; a 54″ bag that requires a 6″ gap ahead and a 6″ gap behind would require a merge window of 66″. A 22″ bag with the same fixed 6″ gap ahead and 6″ gap behind, would only need the next available 34″ minimum window. The invention has also made the dynamic merge gap logic flexible. The front and back gap lengths can be adjusted independently to tune in the greatest throughput without increasing the jam rates.

A preferred form of the invention is made up of a merge conveyor, a power turn, a queue belt, a load belt containing bags from an incoming flight, and a carousel to present the bags for traveler pickup. Software and hardware is utilized to control the security claim conveyor system.

One preferred embodiment of the invention includes a 45-degree merge conveyor, a 45-degree power turn, a queue conveyor, a load conveyor, a flat plate claim carousel, a control system, and a software program to manage the conveyors. In some embodiments, the use of the queue belt would hamper smooth flow or baggage and increase load belt stoppages.

One of the primary advantages of this invention is enhanced security and safety, as well as smooth trouble-free operation.

Another primary advantage of this invention is that it can be built in the existing footprint of the facility architecture.

### DESCRIPTION OF FIGURE

FIG. 1 is a plan view of the secure claim apparatus.

### DETAILED DESCRIPTION OF THE INVENTION

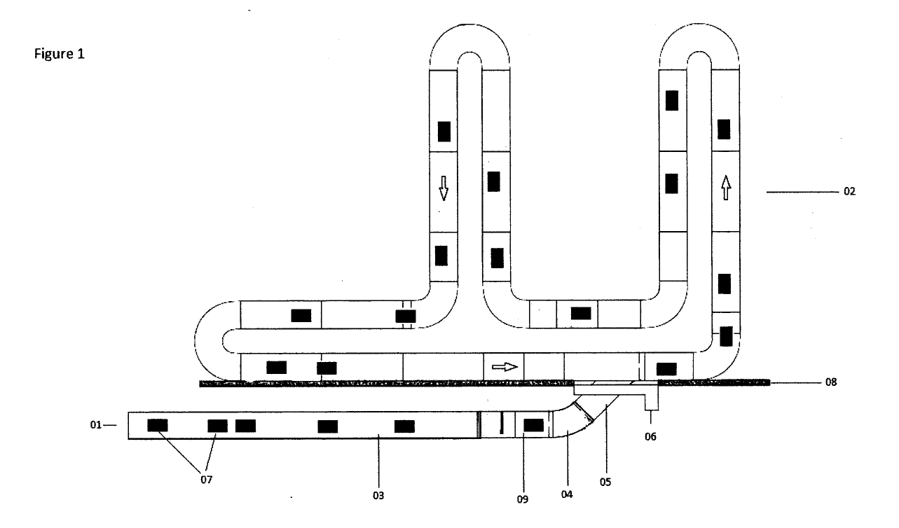

FIG. 1 shows a preferred embodiment of the present invention wherein a dynamic merge conveyor unit 01 is positioned on the secure side of a facility. The dynamic merge conveyor unit 01 extends to, protrudes through or connects to a baggage claim device or carousel 02 on the non-secure side of a facility through an opening or securing opening 06 for delivering baggage 07 onto the baggage claim device 02 on the secure side of a facility. The dynamic merge conveyor unit 01 in FIG. 1 shows a load belt 03, queue belt or conveyor 09, power turn 04 and a merge conveyor 05. The load belt 03 is the conveyor section that the baggage handlers on the secure side of a facility deposit baggage 07 from incoming flights. The baggage 07 will then be transported by the load belt 03 to a queue conveyor 09 for measuring of baggage 07 length. In certain embodiments, the queue conveyor 09 may be deleted or not used. After being measured, the baggage 07 will then proceed through a power turn 04 to a merge conveyor 05 to await dynamic merging onto a baggage claim device 02 on the non-secure side through an opening 06 on the wall 08 between the secure and non-secure side of the facility. Once a bag is deposited onto the baggage claim device 02, it will not be able to circulate back into the secure side of the facility since the baggage claim device 02 is positioned on the non-secure side of the facility wall 08. In the present invention, a wall 08 separates the baggage claim device 02 on the non-secure side from the dynamic merge conveyor unit 01 located on the secure side of the wall 08.

(Not shown) Presently, baggage claim devices 02 pass from the secure side to the non-secure side due to a baggage claim device 02 being built partly on the secure side and partly on the non-secure side. There is no merge conveyor unit. The wall 08 in present configurations cuts the baggage claim device 02 into two separate parts by two openings in the wall 08. Presently, baggage handlers manually place the incoming bags on the baggage claim device 02 and bags circulate from secure to non-secure sides.

The dynamic merge conveyor unit 01 has at least one load conveyor 03 where bags are loaded by a baggage handler. The load conveyor 03 can be of varying length depending on the design, the facility size, the busy-ness of the claim device 02 and/or the throughput requirements of a claim device 02. The dynamic merge conveyor unit 01 may have a queue conveyor 09 of varying length depending on the design, the facility size, busy-ness of the claim device 02 and/or the throughput requirements of a claim device 02. Standard software and controls with varying number of standard photo eyes (not shown) are used to determine baggage 07 lengths. Once sufficient space is determined by the standard controls logic program using a network of standard photo eyes, a bag will then move forward through the power turn 04 to the merge conveyor 05 to await deposit onto the baggage claim device 02. Currently, baggage handling systems employed in airports throughout the U.S. and the world use photo eyes and controls logic to move baggage 07 seamlessly through the maze of conveyor systems similar to the controls logic programming employed to run red lights in city traffic. In certain embodiments, the power turn 04 may be deleted.

The dynamic merge conveyor unit 01 may have a power turn conveyor 04. Power turns 04 are commonly used in baggage handling systems. The power turn 04 may be of varying degrees such as 30 or 45 degrees or spiral; however, depending on the system design, the space available in a facility, a power turn 04 can be of any available degree or custom made.

The dynamic merge conveyor unit's 01 merge conveyor 05 is used to deposit a bag onto the circulating baggage claim device 02. Merge conveyors 05 are commonly used in baggage handling systems. The merge conveyor 04 may be of varying degrees depending on design, facility space, etc. A preferred embodiment of the merge conveyor 05 will typically be 45 degrees; however, the merge conveyor 05 can be of varying degrees.

A preferred method of the present invention delivers incoming baggage 07 securely to a baggage claim unit 02. In the present invention's method, an unload operations personnel or baggage handler will transfer baggage 07 from an airline tug carts to the load conveyor 03, as shown in FIG. 1, the load conveyor 03 will advance said baggage 07 to a queue belt or conveyor 09 for length measurement using standing baggage handling software controls programming and photo eyes, then to a power turn 09 then to a merge conveyor 05; the merge conveyor 05 will hold the baggage 07 until an adequate gap between baggage 07 already on the claim device 02 is measured; the merge conveyor 05 will then perform a dynamic merge on the waiting baggage 07 into a gap on the baggage claim device 02 for pickup by a traveler; when there is not sufficient spacing of baggage 07 on a baggage claim device 02, the merge conveyor 05, the power turn 09, and the queue belt 09 will act as a storage conveyor; once sufficient space is determined by the merge conveyor 05 through the software and photo eyes, the merge conveyor 05 will resume operation by automatically inserting the stored or waiting bags onto the baggage claim device 02.

The method employed by the present invention prevents bags from circulating back and forth from the secure side to the non-secure side, thus preventing an individual on the non-secure side from depositing an unscreened bag on the baggage claim device 02 to a person on the secure side of the facility. Present apparatuses and methods allow any person on the secure side to deposit an unscreened bag on the baggage claim device 02 which is then transported to the secure side where an individual on the secure side can transport the bag onto any airplane without any security screening whatsoever.

Although the invention has been described with reference to preferred embodiments, various substitutions, rearrangements, and alterations might be made, and still the result would be within the scope of the invention.

The disclosure set forth above may encompass multiple distinct inventions with independent utility. While the invention has been disclosed in its preferred form, specific embodiments thereof as disclosed and illustrated herein are not to be considered in a limiting sense as numerous variations are possible. The subject matter of the inventions includes all novel and nonobvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements. It is, believed that the claims particularly point out certain combinations and subcombinations that are directed to one of the disclosed inventions and are novel and nonobvious. Inventions embodied in other combinations and subcombinations of features, functions, elements and/or properties may be claimed through amendment of the present claims or presentation of new claims in this or a related application. Such amended or new claims, whether they are directed to a different invention or directed to the same invention, whether different, broader, narrower or equal in scope to the original claims, are also regarded as included within the subject matter of the inventions of the present disclosure.

This invention claimed is:

A1. A baggage claim apparatus comprising:
at least one dynamic merge conveyor unit for delivering baggage onto a baggage claim device on a secure side of a facility; and
at least one baggage claim device on a non-secure side of a facility.

A2. A baggage claim apparatus as claimed in claim A1 wherein said dynamic merge conveyor unit has at least one load conveyor where bags are loaded by a baggage handler.

A3. A baggage claim apparatus as claimed in claim A1 wherein said dynamic merge conveyor unit has at least one queue conveyor to measure bag spacing and length.

A4. A baggage claim apparatus as claimed in claim A1 wherein said dynamic merge conveyor unit has at least one power turn conveyor.

A5. A baggage claim apparatus as claimed in claim A1 wherein said dynamic merge conveyor unit is a dynamic merge that measures gap space between bags and merges a bag once adequate space is determined.

A6. A baggage claim apparatus as claimed in claim A1 wherein said dynamic merge conveyor unit uses software logic to control and manage the secure baggage claim apparatus.

A7. A baggage claim apparatus comprising:
at least one load conveyor for placing baggage;
at least one queue conveyor;
at least one merge conveyor; and
at least one claim device.

A8. A baggage claim apparatus as claimed in claim A7 wherein said load conveyor is where bags are initially loaded on the secure baggage claim apparatus by a baggage handler.

A9. A baggage claim apparatus as claimed in claim A7 wherein said queue conveyor measures bag spacing and length.

A10. A baggage claim apparatus as claimed in claim A7 wherein said merge conveyor is a dynamic merge that will merge a bag onto the claim device once adequate baggage space is measured.

A11. A baggage claim apparatus comprising:
at least one load conveyor;
at least one queue conveyor;
at least one power turn;
at least one merge conveyor; and
at least one claim device.

A12. A baggage claim apparatus as claimed in claim A11 wherein said load conveyor is where bags are initially loaded on the secure baggage claim apparatus by a baggage handler.

A13. A baggage claim apparatus as claimed in claim A11 wherein said queue conveyor measures bag spacing and length.

A14. A baggage claim apparatus as claimed in claim A11 wherein said power turn is of varying degrees.

A15. A baggage claim apparatus as claimed in claim A11 wherein said merge conveyor is a dynamic merge that will merge a bag onto the claim device once adequate baggage space is measured.

A16. A method wherein bags are delivered securely to a baggage claim unit, wherein unload operations personnel will transfer baggage from an airline tug carts to a load conveyor; said load conveyor advances said baggage to a queue belt for length measurement using a software controls program, then through a power turn, to a merge; said merge will hold said baggage until an adequate gap between baggage already on a claim device is measured; said merge will then perform a dynamic merge on the waiting said baggage into a gap on baggage claim device for pickup by a traveler; when there is not sufficient spacing of baggage on a baggage claim device, said merge, said power turn, said queue and said load conveyor will act as a storage conveyor; once sufficient space is determined by said merge, said merge will resume operation by automatically inserting said stored bags onto said baggage claim device.

A17. The method according to claim A16, wherein said software controls program uses program logic to control and manage the secure baggage claim method of operation.
